(19) United States
(12) Patent Application Publication
(10) Pub. No.: US 2002/0005813 A1
(43) Pub. Date: Jan. 17, 2002

(54) Shaped reflector antenna assembly

(76) Inventors: William J. Comisky, Oakland, CA (US); Raymond R. Blasing, Los Altos, CA (US)

Correspondence Address: LAW OFFICE OF EDWARD B ANDERSON, 3822 GOLDEN EAGLE LOOP, S.E., OLYMPIA, WA, 98513

(21) Appl. No.: 09/765,979

(22) Filed: Jan. 19, 2001

Related U.S. Application Data
(60) Provisional application No. 60/177,254, filed on Jan. 20, 2000.

(51) Int. Cl. H01Q 13/00; H01Q 19/12

(52) U.S. Cl. 343/840; 343/779

(57) ABSTRACT

A single offset-fed reflector antenna includes a serpentine waveguide terminating with a corrugated horn feed directed at a reflector having a focal length of about half of the diameter of the reflector for providing a 90-degree azimuth and 6-degree elevation beam at 38 GHz. A semi-cylindrical radome, end caps and base plate form an enclosure for the waveguide, feed, and reflector. The reflector has a continuous compound concave/convex surface.

### CROSS-REFERENCE TO RELATED APPLICATIONS

This application claims the benefit of U.S. Provisional Application No. 60/177,254, filed Jan. 20, 2000.

### BACKGROUND OF THE INVENTION

The present invention relates to the field of microwave antennas, and in particular to such antennas having offset-fed shaped reflectors.

In cell-based communication systems for point-to-multipoint transmission systems, a “hub” is located at the center of a usually round “cell.” Omni directional azimuth radiation is obtained by an arrangement of wide beam antennas, each covering a sector of the cell. Each hub transceiver antenna is generally mounted on an elevated tower or building roof, and transmits to and receives signals from customer-premise equipment in the form of transceiver and antenna devices.

As an example, the hub site may consist of four 90-degree azimuthal sectors which, when combined, service the entire 360-degree cell area. The antenna, which is attached to and many times integrated with the radio transceiver unit, must effectively provide uniform power coverage within its sector and suppress unwanted radiation that may tend to leak into adjacent sectors or neighboring cells. Further, the antenna must suppress energy above the horizon that may interfere with satellite-based communication systems. The ideal antenna also must be capable of operating over assigned bandwidths (such as 28 to 31 GHz) without degradation of performance, and must be highly efficient.

Historically, the radiation pattern has been formed by the use of antenna arrays, slot antennas and beam horns. These configurations tend to be large and generally complex in structure. Shaped reflectors are commonly used for satellite communication. Recently, it has been found that shaped reflectors may be used for point-to-multipoint terrestrial communication as well. The shaped reflectors that produce narrow beams appropriate for satellite communication are found to be inadequate for the wide azimuthal beams required for terrestrial hubs.

### BRIEF SUMMARY OF THE INVENTION

The present invention provides a shaped reflector antenna that provides improved performance characteristics, satisfying the stringent requirements of a sector-based terrestrial communication system.

Generally, a shaped offset-fed reflector antenna made according to the invention includes an antenna feed, a reflector having a reflector surface, and a support for the feed and reflector for providing a wave path between the feed and the reflector. At least a portion of the reflector surface is convex.

The preferred embodiment of the invention is a single offset-fed reflector antenna including a semi-cylindrical radome covering the reflector in the region of the beam produced by the reflector. Further, the support includes a base plate having an aperture. The antenna preferably includes a waveguide coupling the aperture to the feed, a waveguide support for supporting the waveguide relative to the base plate, and end caps covering the ends of the radome. The radome, end caps and base plate form an enclosure for the waveguide, waveguide support, feed, and reflector. The reflector has a focal length of about one-half of the diameter of the reflector, making the assembly very compact.

The preferred embodiment of the shaped reflector provides a 90-degree azimuth and 6-degree elevation beam at 38 GHz. The convex portion of the reflector surface is generally centrally located when viewed in cross section from a horizontal plane, and has a convex region near the top when viewed in cross section from a vertical plane. The reflector is symmetrical about a vertical plane and is formed of a cylindrical metal stock.

It is seen that the preferred antenna assembly includes an offset-fed shaped reflector mounted in a radome cover. The reflector shape is obtained by an iterative optimization process that produces a continuous compound concave/convex surface providing a radiation beam having a broad width in azimuth and controlled elevation profile that are typically realized by the use of antenna arrays or sectoral horns. A focal length to reflector diameter ratio of less than one is used to provide a compact structure made possible by a dramatic reflector shape. The antenna preferably provides null-filled pattern shaping in elevation, a broad, flat beam in azimuth, aggressive side lobe suppression in azimuth without dynamic adjustment or tuning, high efficiency and broad frequency bandwidth. These and other features and advantages of the present invention will be apparent from the preferred embodiments described in the following detailed description and illustrated in the accompanying drawings.

### BRIEF DESCRIPTION OF THE SEVERAL VIEWS OF THE DRAWINGS

FIG. 1 is a front isometric view of an antenna assembly made according to the invention.

FIG. 2 is a rear isometric view of the antenna assembly of FIG. 1.

FIG. 3 is a rear elevation of the antenna assembly of FIG. 1.

FIG. 4 is an exploded rear isometric view similar to FIG. 2.

FIG. 5 is an exploded side isometric view showing the assembly of a radome cover of the antenna assembly of FIG. 1.

FIGS. 6 and 7 are exploded views of the feed assembly of the antenna assembly of FIG. 1 showing alternative orientation of a corrugated feed horn.

FIG. 8 is a partial exploded view of the feed assembly of the antenna assembly of FIG. 1 without the radome cover or mounting arm.

FIG. 9 is an isometric view of a cylinder of metal stock used for manufacturing a shaped reflector according to the invention with a potential reflector surface shown in dashed lines.

FIG. 10 is a top right isometric view of the microwave antenna shaped reflector included in the antenna assembly of FIG. 1 and made according to the invention; the top left isometric view being a mirror image.

FIG. 11 is a rear left isometric view of the shaped reflector of FIG. 10, the rear right isometric view being a mirror image.

FIG. 12 is a front elevation of the shaped reflector of FIG. 10.

FIG. 13 is a rear elevation of the shaped reflector of FIG. 10.

FIG. 14 is a right side elevation of the shaped reflector of FIG. 10, the left side elevation being a mirror image.

FIG. 15 is a top plan view of the shaped reflector of FIG. 10.

FIG. 16 is a cross-section taken along the line 16-16 in FIG. 15, corresponding to the plane X=2.5 defined in FIG. 10.

FIG. 17 is a cross-section taken along the line 17-17 in FIG. 15, corresponding to the plane X=4.0 defined in FIG. 10.

FIG. 18 is a cross-section taken along the line 18-18 in FIG. 15, corresponding to the plane X=5.5 defined in FIG. 10.

FIG. 19 is a cross-section taken along the line 19-19 in FIG. 15, corresponding to the plane Y=1.5 defined in FIG. 10, the cross-sectional view taken along the plane Y=−1.5 being the same.

FIG. 20 is a cross-section taken along the line 20-20 in FIG. 15, corresponding to the plane Y=0 defined in FIG. 10.

### DETAILED DESCRIPTION

### OF THE PREFERRED EMBODIMENT OF THE INVENTION

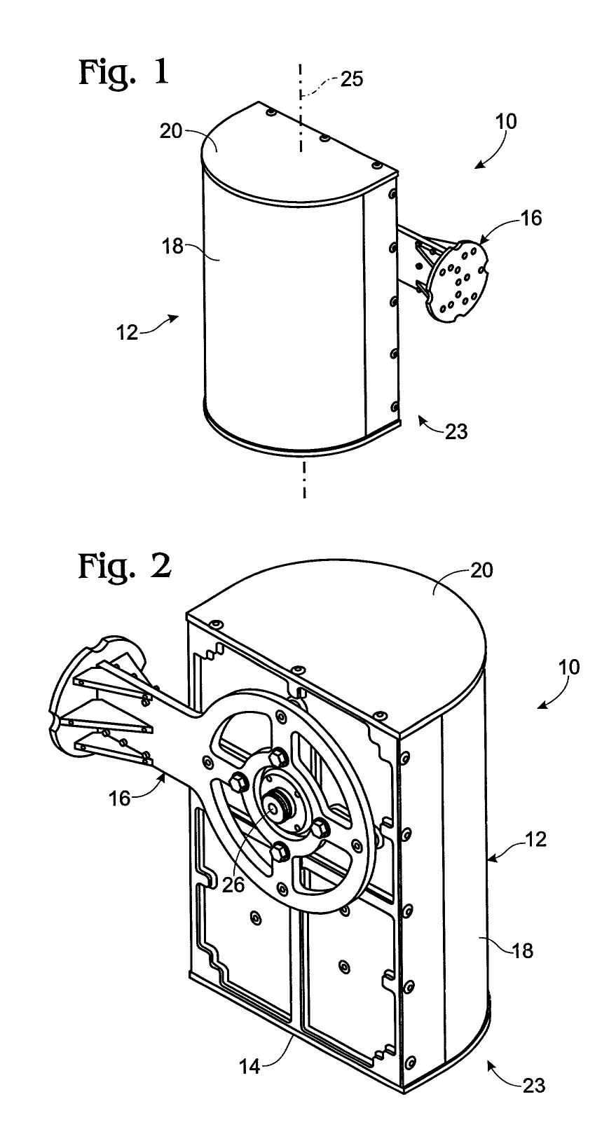

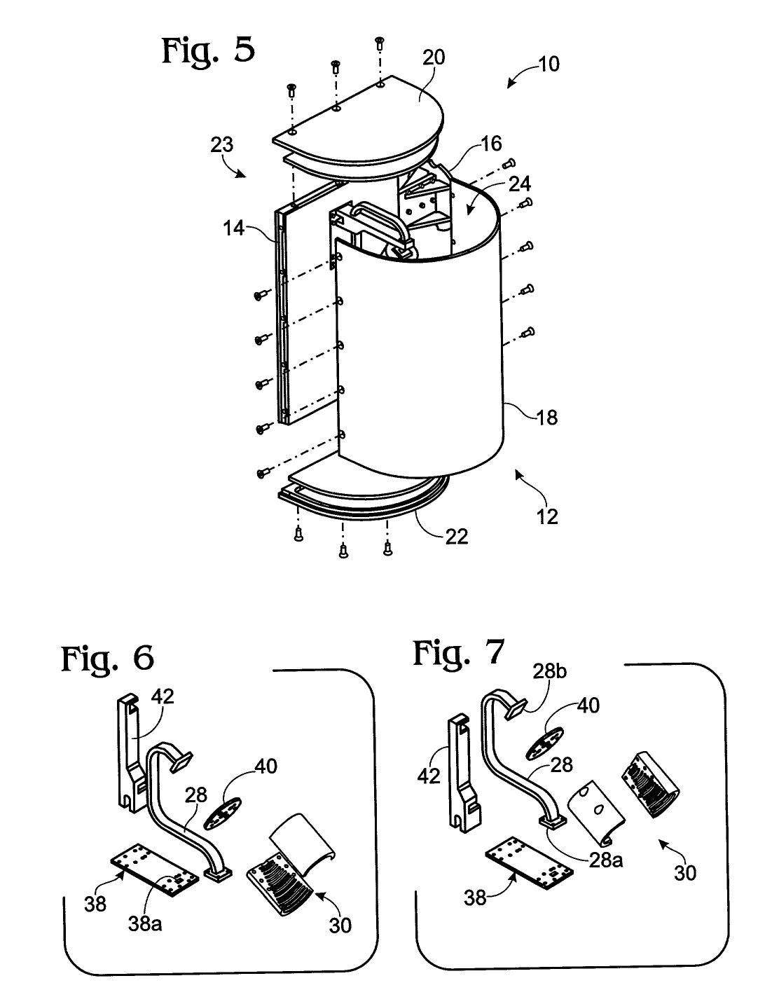

Referring initially to FIGS. 1-5, the design of a microwave antenna assembly 10 made according to the invention is shown. Antenna assembly 10 provides a beam having a half-power width in azimuth of 90 degrees and a height in elevation of 6 degrees at 38 GHz. The invention also applies to other beam patterns and frequencies. Assembly 10 includes a radome cover assembly 12 mounted to a base plate 14. An antenna mounting arm 16, for mounting the antenna assembly to a pole-mounting assembly is rigidly mounted to the backside of the base plate, as particularly shown in FIGS. 2-4.

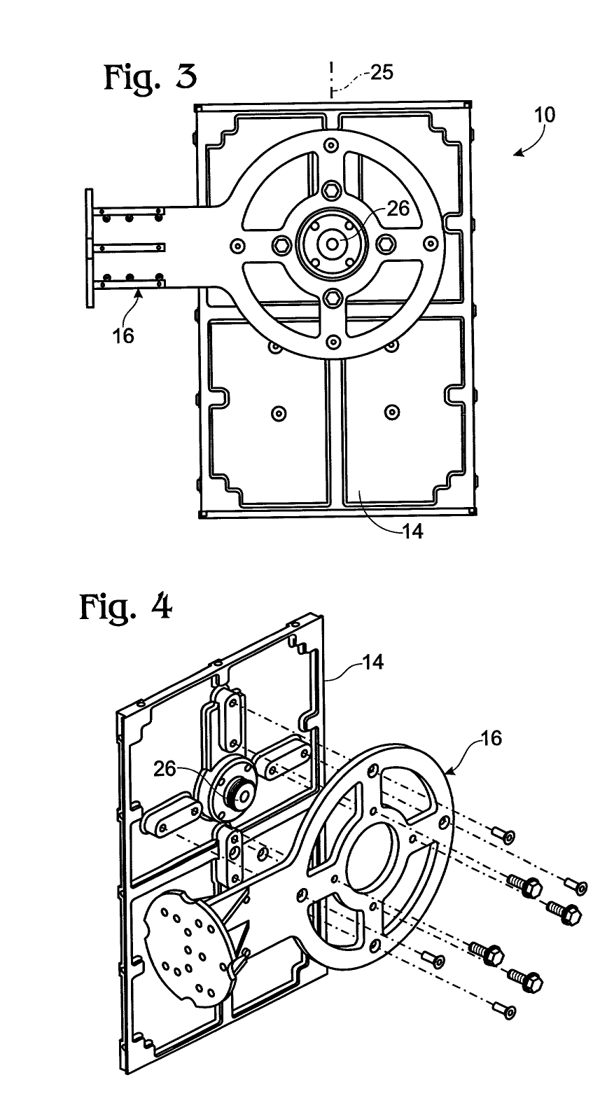

As shown, base plate 14 has an elongate rectangular shape. Radome cover assembly 12 includes an elongate semi-cylindrical radome cover 18 and semi-circular ends 20 and 22 that provide a full enclosure 23 of an antenna 24 mounted to the base plate under the cover. As shown in FIG. 3, the radome cover is seen to have a longitudinal axis 25 that is perpendicular to ends 20 positioned horizontally in the preferred embodiment. The radome cover thus provides a continuous curved surface for the wide-angle beam to pass through. Alternative implementations may include other custom shapes, and the shape may be made with a fully formed or molded surface. Microwave communication signals are fed to antenna 24 via a waveguide coupler 26 mounted in base plate 14, as shown.

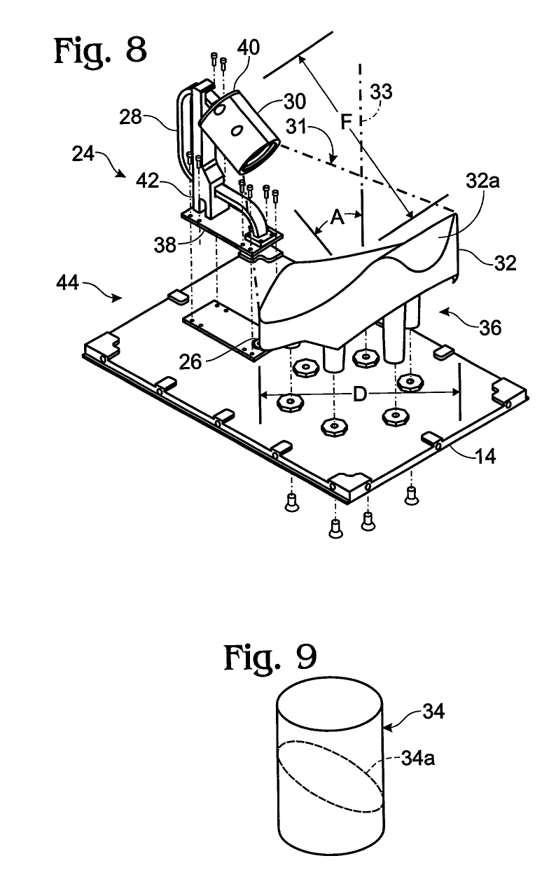

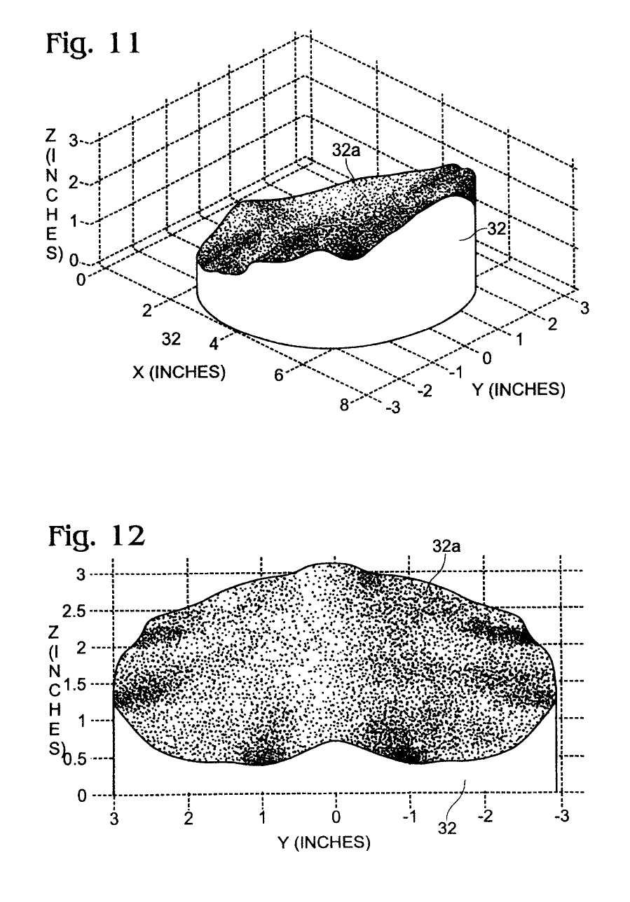

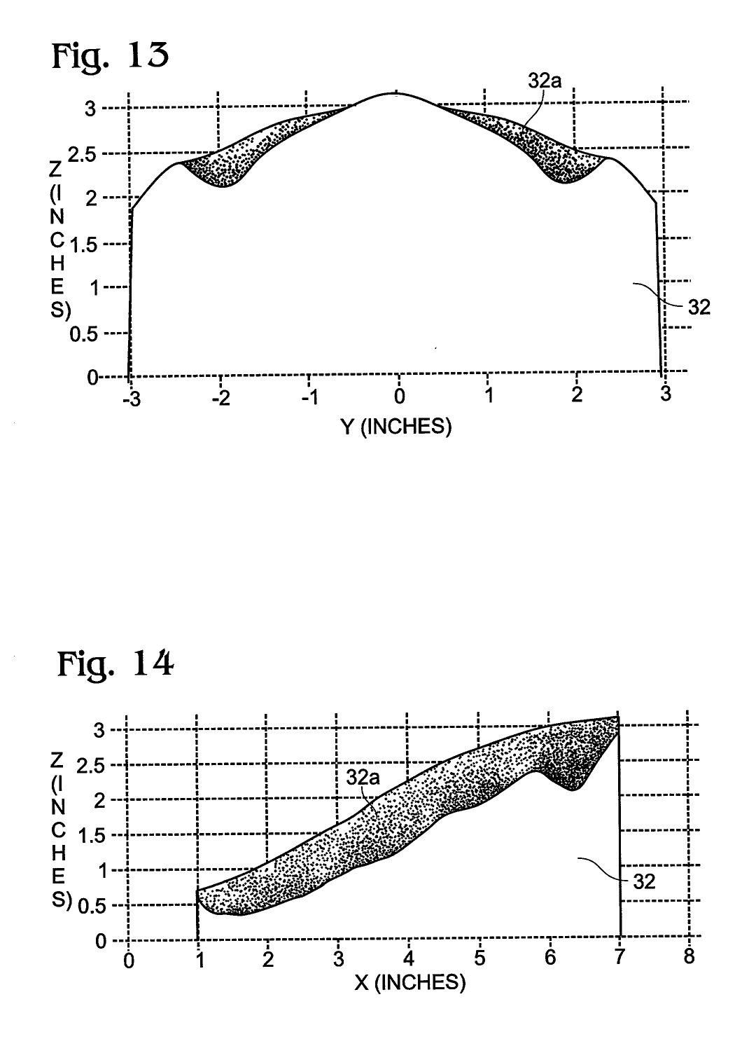

Referring now to FIGS. 6-8, antenna 24 includes a waveguide 28, a corrugated feed horn 30, also referred to simply as a feed, and a shaped reflector 32. As shown particularly in FIG. 8, the feed horn is offset from the central axis 33 of reflector 32 by an offset angle A. The central axis is also referred to as the bore sight of the antenna or the axis of the beam produced by the antenna. The feed horn in FIG. 7 is rotated in orientation about the feed axis of the horn 90 degrees relative to the orientation shown in FIG. 6. The dimension F represents approximately the focal length of the antenna. The actual focal length, as it is conventionally understood, corresponds to the distance from the center of the feed horn aperture to a point on plate 38 along the axis of a parabola approximately containing the reflector surface. The axis of this parabola is the Z-axis at X=Y=0 in the coordinate system of FIGS. 10-14.

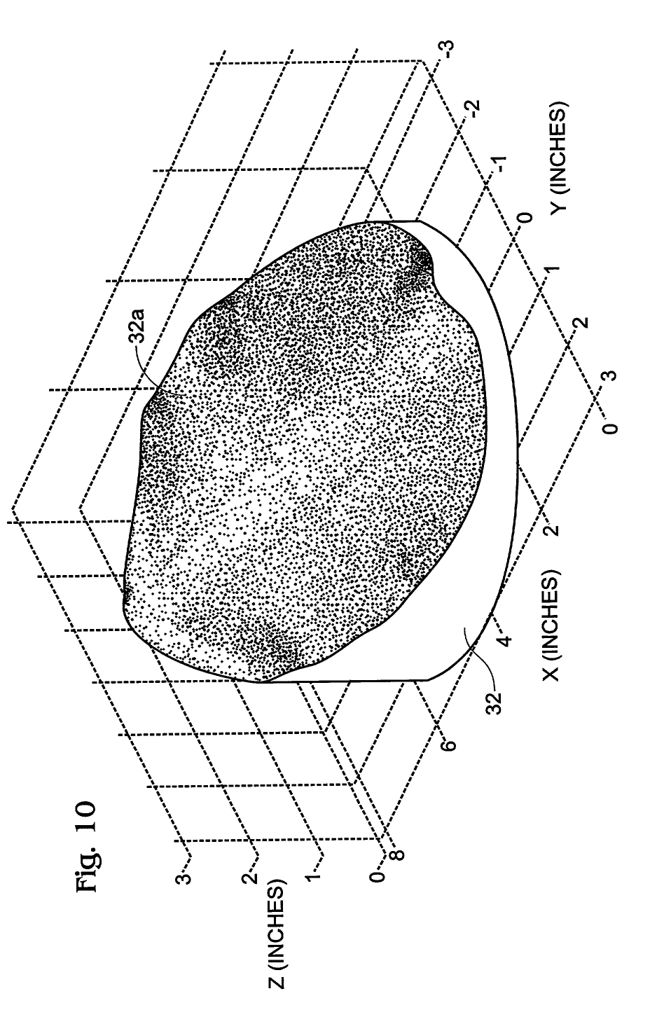

The feed horn thus defines a wave path, shown generally at 31, between the feed horn and reflector. The reflector may be made of a cylindrical metal stock 34, shown in FIG. 9 having a diameter D, or it may be cast. Reflector 32 shown in FIG. 8 was cast and is supported at a fixed orientation relative to base plate 14 on legs 36. Dashed line 34a in FIG. 9 represents the initial position for the shaped reflector surface. The metal body of the shaped reflector, whether it was cast or made from a stock 34, is also referred to as a unitary body.

Waveguide 28 is supported in a fixed position relative to plate 14 by a mounting plate 38 having a waveguide opening 38a aligned with waveguide coupler 26. Coupler 26 serves as a base plate/waveguide transition that converts the electromagnetic linear fields present within waveguide 28 to linear fields within the waveguide (not shown) attached to the other side of the base plate. Waveguide 28 has a base end 28a aligned with opening 38a, and a suspended or feed end 28b. Feed horn 30 is mounted to waveguide end 28b by a circular plate 40 that functions like coupler 26 to provide a rectangular to circular waveguide transition. This transition is not necessary if the feed waveguide is circular. The waveguide follows a serpentine path from plate 38 and is supported in the suspended position by an upright 42. It will be understood that other waveguide sources and shapes may also be used. Waveguide 28, upright 42 and base plate 14 are included in what is referred to as a support assembly 44. If the waveguide is sufficiently rigid, upright 42 is not necessary.

The corrugated horn is designed to optimally illuminate the surface of the shaped reflector. The phase center of the horn, as determined through conventional mode-matching techniques, is positioned at the virtual focus of the offset reflector, and illuminates the reflector with the proper (primary) illumination pattern to provide low spillover energy. The horn preferably provides −25 dB of roll-off at the edge of the reflector boundary.

Reflector 32 has a shaped surface 32a having a contour illustrated in FIGS. 10-20. The position and grid for the X, Y and Z axes used to define the shaped surface are shown in the figures. This same convention is followed for the definition of surface points given in the table of Appendix A, which table defines the shape of the reflector surface shown in the figures. The cross-sectional views show that the surface is symmetrical about a plane 106 corresponding to Y=0 and generally has a convex contour for cross-sections taken normal to plane 46, as shown in FIGS. 16-18.

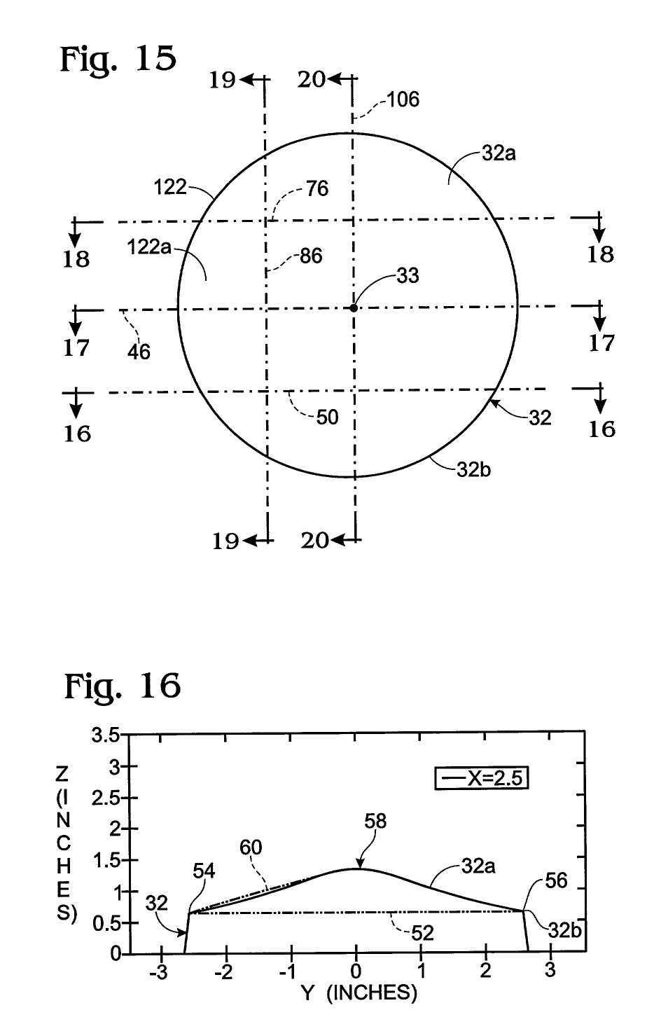

FIG. 16 illustrates a cross section taken along line 16-16 in FIG. 15. The plane of view of this figure is represented by the plane 50 identified in FIG. 20, corresponding to Y=2.5. In FIG. 16 it is seen that the entire curve of surface 32a in plane 50 lies above a line 52 of construction extending between peripheral points 54 and 56 on the outer rim or periphery 32b of reflector 32. The surface in this view is thus seen to be generally convex, particularly in the central portion 58. It is seen, though, that a line, such as line 60 in plane 50, connects points on the surface, below which the surface is concave in the side regions, such as region 61 adjacent to the periphery of the surface. It is seen, then, that surface 32a is both convex and concave in this cross section.

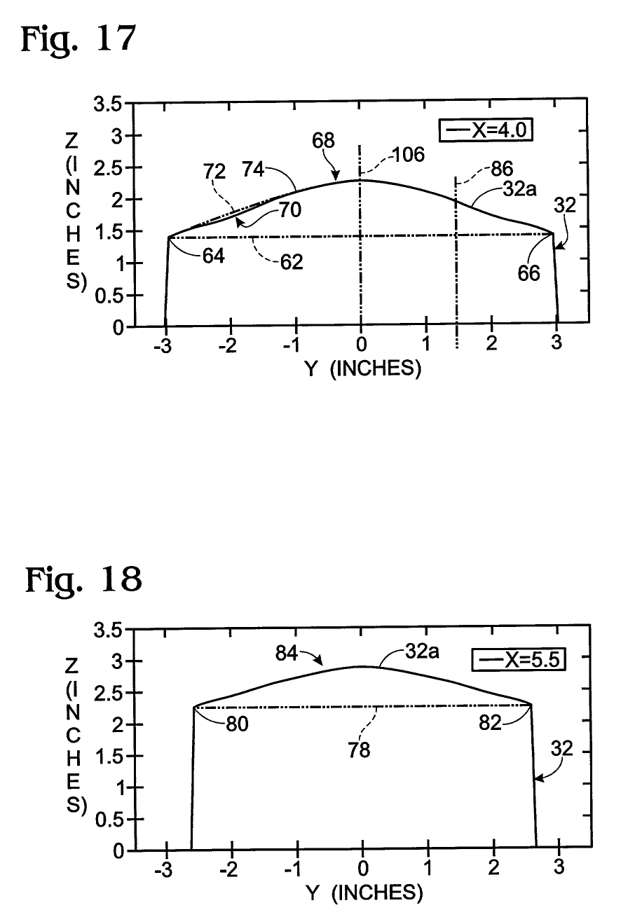

FIG. 17 illustrates the cross section through the center of reflector 32 as viewed in plane 46 and taken along line 17-17 in FIG. 15. Again the surface lies entirely above a straight line of construction 62 extending between two points 64 and 66 on the surface periphery. As in the cross section of FIG. 16, the surface is seen to be generally convex, particularly in a central region 68. The surface is also concave in the peripheral regions, such as region 70 below a line of construction 72 extending between two spaced-apart points 64 and 74 on the reflector surface.

FIG. 18 illustrates the cross section through reflector 32 as viewed in a plane 76 identified in FIG. 20 corresponding to Y=5.5, and as taken along line 18-18 in FIG. 15. Again the surface lies entirely above a straight line of construction 78 extending between two points 80 and 82 on the surface periphery. As in the cross section of FIG. 16, the surface is seen to be generally convex, particularly in a central region 84.

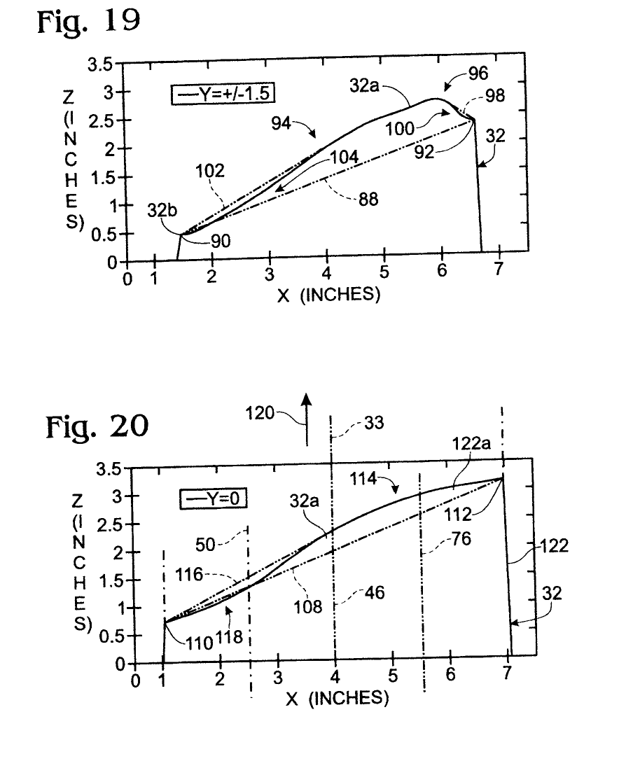

FIG. 19 is a cross section taken along line 19-19 in FIG. 15, which line corresponds to a plane 86 shown in FIG. 17. The cross section plane 86 corresponds to the grid value Y=1.5. The cross section for the grid value Y=−1.5 is the same since the reflector surface is symmetrical about the plane containing the grid value Y=0 as shown in FIG. 15. In FIG. 19 it is noted that most of the surface lies above a line of construction 88 extending between periphery points 90 and 92. A central region 94 that extends up to adjacent point 92 on the surface periphery is seen to be convex.

The convexity drops off dramatically at the upper edge or periphery, forming a pronounced protuberance 96 particularly identifiable in the isometric views of FIGS. 10-13. A short construction line 98 connecting point 92 to the surface at the protuberance shows that the surface is still slightly concave immediately adjacent to the surface periphery at a region 100. The surface adjacent to periphery point 90 is seen to be much more broadly concave, as indicated by the surface line passing below a line of construction 102 extending along a region 104 between point 90 and central region 94.

FIG. 20 is a cross section taken along line 20-20 in FIG. 15, which line corresponds to a plane 106 shown in FIG. 17, which plane is perpendicular with plane 46, as shown in FIG. 15. Plane 106 is the plane of symmetry of the reflector surface and corresponds to the grid value Y=0. A line of construction 108 extending between reflector periphery points 110 and 112 shows that the reflector surface is disposed predominantly above the line and is primarily convex along a region 114. The surface adjacent to periphery point 110 is seen to be broadly concave, as indicated by the reflector surface line passing below a line of construction 116 extending along a region 118 above point 110.

Planes 46, 50 and 76 are parallel to each other, and they are perpendicular to planes 86 and 106. Planes 86 and 106 are accordingly parallel to each other. All of these planes are parallel to the beam axis 33.

As has been discussed, reflector surface 32 radiates a beam 120, represented by arrow 120 in FIG. 20, along axis 33 that nominally has an azimuth beam width of 90 degrees and an elevation beam width of 6 degrees at 38 GHz. Reflector shapes that provide other beam patterns or to operate at other frequencies may be used. As shown in the figures, reflector surface 32a is preferably formed as one end 122a of a unitary body 122 having a circular cylindrical form, as particularly shown in FIG. 15. Body 122 may be cast, as shown in FIG. 8 or formed from stock as shown in FIG. 9. It will be appreciated, though, that the reflector surface could be formed as part of a material or body that extends outwardly from periphery 32b.

An alternative embodiment of the antenna is as a dual offset reflector antenna. This geometry makes use of a feed and feed horn that illuminates a shaped subreflector. This energy is then reflected onto the surface of a shaped primary reflector. The primary reflector is shaped to reflect the energy with the desired pattern characteristics. In this embodiment, the primary reflector is shaped to generate cross polarization energy that exactly compensates for or cancels undesirable cross polarization energy generated by the subreflector.

The data points given in the table in Appendix A may be used to form the shaped reflector shown in the figures. The data in this table was derived using commercially available optimization computer software. By the use of the optimization routine, the reflector surface was designed so that, when illuminated by the energy radiated by the feed horn (primary radiation), it provides the desired radiation pattern (secondary radiation). Conventional shaped reflector surfaces generally provide “contoured” patterns that encompass land mass (satellite applications). The aspect ratio of these patterns (ratio of azimuth angle extent to elevation angle extent) generally ranges from 1:1 to perhaps 4:1. The preferred antenna provides an aspect ratio of about 15:1, corresponding to 90-degree azimuth by 6-degree elevation. The resulting reflector surface is generally convex in azimuth and concave/convex in elevation. The reflector surface is preferably symmetric about the vertical (azimuth) axis and highly asymmetric about the horizontal (elevation) axis, as required, to provide asymmetrical elevation pattern shaping. Although not shown, an absorber may be applied to edges of the reflector surface, in order to reduce or eliminate the effects of unwanted diffracted energy. The reflector surface can be machined or cast for low cost high volume manufacture.

An inherent feature of the preferred reflector is that residual cross-polarized energy is generated as an artifact of the reflector surface and offset geometry. This effect tends to be increasingly pronounced with increasing azimuth beam width. To eliminate the effect of this resultant cross polarization, external polarizer “cleansing” grids, not shown, are attached to the inner surface of the radome. These parallel conductive traces or wires are generally etched on a substrate sheet (carrier) and the sheet is bonded to the inner radome surface. The angular orientation of the grids is dependent upon the polarization of the antenna. For example, a vertical antenna provides transmission and reception of vertically linear polarized energy. A small amount of horizontal linear polarized energy is generated which needs to be suppressed. To accomplish this, the grids are oriented horizontally such that the horizontal energy is generally incident on and reflected by the grids, rather than being transmitted through the radome.

Although the present invention has been described in detail with reference to a particular preferred embodiment, persons possessing ordinary skill in the art to which this invention pertains will appreciate that various modifications and enhancements may be made without departing from the spirit and scope of the claims as written and as judicially construed according to principles of law. The above disclosure is thus intended for purposes of illustration and not limitation.

The invention claimed is:

1. A shaped offset-fed reflector antenna assembly comprising:
an antenna feed;
a reflector having a reflector surface, at least a portion of the reflector surface being convex; and
a support assembly supporting the feed and reflector for providing a wave path between the feed and the reflector.

2. An antenna assembly according to claim 1 wherein the convex portion of the reflector surface is generally centrally located.

3. An antenna assembly according to claim 2 wherein the reflector surface has a periphery and includes at least one portion adjacent to the periphery that is also concave.

4. An antenna assembly according to claim 1 wherein the reflector surface has a periphery and includes at least one portion adjacent to the periphery that is also concave.

5. An antenna assembly according to claim 1 wherein the reflector surface has a periphery and there exists two spaced-apart periphery points on the periphery such that the reflector surface extends above a straight line extending between the two periphery points.

6. An antenna assembly according to claim 5 wherein the reflector surface extends above the straight line along the entire length of the straight line.

7. An antenna assembly according to claim 6 wherein a contour of the reflector surface intersecting a plane containing the two periphery points includes a portion that is concave.

8. An antenna assembly according to claim 5 wherein the reflector surface reaches a maximum distance from the straight line adjacent to one of the periphery points.

9. An antenna assembly according to claim 1 wherein the reflector includes a unitary body having an end face forming the reflector surface.

10. An antenna assembly according to claim 1 further comprising a radome covering the reflector in a continuous curve.

11. An antenna assembly according to claim 10 wherein the continuous curve is circular.

12. An antenna assembly according to claim 11 wherein the radome is cylindrical about a vertical axis.

13. An antenna assembly according to claim 12 wherein the support assembly includes a base plate having an aperture, the antenna assembly further comprising a waveguide coupling the aperture to the feed and end caps covering the ends of the radome, the support assembly further including a waveguide support for supporting the waveguide relative to the base plate, wherein the radome, end caps and base plate form an enclosure for the waveguide, feed, and reflector, the reflector having a focal length and diameter with the feed being positioned at a focal length from the reflector of about one-half of the diameter of the reflector.

14. A shaped offset-fed reflector antenna assembly comprising:
an antenna feed;
a reflector having a reflector surface having a periphery and there exists two spaced-apart periphery points on the beam periphery such that at least a portion of the reflector surface extends above a straight line extending between the two periphery points; and
a support assembly supporting the feed and reflector for providing a wave path between the feed and the reflector.

15. An antenna assembly according to claim 14 wherein the reflector surface extends above the straight line along the entire length of the straight line.

16. An antenna assembly according to claim 15 wherein a contour of the reflector surface intersecting a plane containing the two periphery points includes a portion that is concave.

17. An antenna assembly according to claim 14 wherein there exists a first plane containing the two periphery points, and a second plane transverse to the first plane and intersecting the periphery at two additional spaced-apart periphery points, at least a portion of the contour of the reflector surface existing in the second plane extends above a straight line extending between the additional periphery points.

18. An antenna assembly according to claim 14 wherein the reflector surface reaches a maximum distance from the straight line adjacent to one of the periphery points.

19. An antenna assembly according to claim 14 wherein the main reflector includes a unitary body having an end face forming the reflector surface.

20. A shaped offset-fed reflector antenna comprising:
an antenna feed;
a reflector including a unitary body having an end face forming a reflector surface; and
a support assembly supporting the feed and reflector for providing a wave path between the feed and the reflector.

21. A shaped offset-fed reflector antenna assembly comprising:
an antenna feed;
a reflector;
a radome covering the reflector in a continuous curve; and
a support assembly supporting the feed and reflector for providing a wave path between the feed and the reflector.

22. An antenna assembly according to claim 22 wherein the continuous curve is Circular.

23. An antenna assembly according to claim 22 wherein the radome is cylindrical about a vertical axis.

24. An antenna assembly according to claim 23 wherein the beam has a width of ninety degrees and the radome is semi-cylindrical.

25. A shaped offset-fed reflector antenna assembly comprising:
an antenna feed;
a reflector having a diameter; and
a support assembly providing a wave path between the feed and the reflector with the feed positioned at a focal length from the reflector of about one-half of the diameter of the reflector.
